(19) United States
(12) Patent Application Publication
(10) Pub. No.: US 2015/0322297 A1
(43) Pub. Date: Nov. 12, 2015

(54) STRIP STICKER OF QUILTING RULER SET

(71) Applicant: Fang-Chi Yeh, Taipei (TW)

(72) Inventor: Fang-Chi Yeh, Taipei (TW)

(21) Appl. No.: 14/271,468

(22) Filed: May 7, 2014

(51) Int. Cl. C09J 7/04; C09J 127/06; C09J 7/02

(52) U.S. Cl. CPC C09J 7/04; C09J 7/0264; C09J 7/0267; C09J 7/021; C09J 127/06; C09J 2433/006; C09J 2427/00

(57) ABSTRACT

The utility model is to provide a strip sticker of quilting ruler set, which comprises flat quilting ruler in the upper and lower surface, the one surface of which marked with graduations, characterized in that a strip sticker that has first and second side in parallel, and one of two surface coating with a layer of reusable adhesive by which the strip sticker can be used for torn and adhered to quilting ruler repeatedly, said strip sticker is adhered to the other surface of the quilting ruler; the length of the strip sticker is less than the quilting ruler, the first side of the strip sticker needs to align along the one of a graduation line on quilting ruler before sticking together.

### FIELD OF THE INVENTION

The utility model is a strip sticker of quilting ruler set.

### BACKGROUND OF THE INVENTION

Quilting has always been one of the important step in patchwork, it is by having one side of quilting ruler touching the side of cloth, draw a straight line on the cloth along the edge of the quilting ruler, and then sew together for a piece of beautiful patchwork following cutting or unfolding the cloth in different shapes.

The prior art of quilting ruler as shown in FIG. 1 is a flat ruler in the upper and lower surface, one of its surface marked with graduations (11) which is made from straight lines, oblique lines and graduations, but some quilting rulers don't have graduation marked on the surface for different demand, no matter what kind of quilting ruler, the requirement of placing on the cloth and measurement for drawing lines resulted in the step is slow, so inventors had created some improved quilting rulers as shown in FIG. 2 and FIG. 3 that is added a bumping (12) or a groove (13) in one of quilting ruler surface to lean against the edge of cloth for drawing lines quickly, thereby reducing the operating time. Patent documents may refer to U.S. Pat. No. 5,579,670 and U.S. Pat. No. 5,823,086.

Said bumping (12) or groove (13) is arranged in a fixed position of the quilting ruler, in which the single shape of quilting ruler cannot be used when the cloth is needed to be reduced or magnified the size. It is required to spend more money to make different quilting ruler sizes for producing various quilting clothes, it would be an unnecessary waste of money and material, and moreover, too many quilting rulers will result in misuse easily or mess up on the table. Besides, the making of said bumping or groove is require to be molding, grinding and then polishing with a lot of work for making process, which increased the cost of production and time.

In view of this, how to solve the problem of the existence of the above, it will become an urgent need to improve the subject.

In order to solve the technical problem, the technic proposal of the utility model is that a strip sticker of quilting ruler set is a flat quilting ruler in the upper and lower surface, the one surface of which marked with graduations, which is characterized in that a strip sticker that has first and second side in parallel, and one of two surface coating with a layer of reusable adhesive by which the strip sticker can be used for torn and adhered to quilting ruler repeatedly, said strip sticker is adhered to the other surface of the quilting ruler; the length of the strip sticker is less than the quilting ruler, the first side of the strip sticker needs to align along the one of a graduation line on quilting ruler before sticking together.

As a preferred embodiment of the present invention, said reusable adhesive is covered by a removable release paper prior to use.

As a preferred embodiment of the present invention, said reusable adhesive is made of a water-based PVC adhesive.

As a preferred embodiment of the present invention, the thickness of the strip sticker is no more than the one of the quilting Ruler, but it must be greater than 0.3 mm.

As a preferred embodiment of the present invention, the width of the strip sticker is between 0.7 mm and 2 cm preferably.

As a preferred embodiment of the present invention, said strip sticker is a soft plastic strip sticker.

As a preferred embodiment of the present invention, said strip sticker is a toughness of paper material, said paper material is a waterproof preferably.

As a preferred embodiment of the present invention, said strip sticker is an acrylic material.

In accordance with a preferred embodiment of the present invention, the invention has the advantage of:
1. The easily-torn strip sticker can change the position of quilting ruler anytime for making different size of cloth, which solves the inflexibility of use of bumping and groove inflexibly.
2. The quilting ruler and the strip sticker in the present invention are made separately, which are low cost in manufacture due to produced easily and no need for mechanical processing; moreover, the strip sticker can use repeatedly with the reusable adhesive, it is convenient to operate and easy to realize.
3. The one single quilting ruler replaces many others of different size of prior art, so the table will not mess up easily, nor will take the quilting ruler by mistake.
4. The one quilting ruler not only could save materials but also reduce the cost.

### BRIEF DESCRIPTION OF THE DRAWINGS

FIG. 1 is a perspective schematic view of the first prior art embodiment.

FIG. 2 is a perspective schematic view of the second prior art embodiment.

FIG. 3 is a perspective schematic view of the third prior art embodiment.

FIG. 4 is a schematic view of a combination structure of the utility model.

FIG. 5 is an exploded view of quilting ruler of the utility model.

FIG. 6 is an implementation schematic view of quilting ruler with cloth of the utility model.

FIG. 7 is a sectional view of quilting ruler with cloth of the utility model.

FIG. 8 and FIG. 9 are schematic views showing a line drawing on cloth by quilting ruler of the utility model.

FIG. 10 is a schematic view showing the strip sticker adhered to oblique line of the quilting ruler of the utility model.

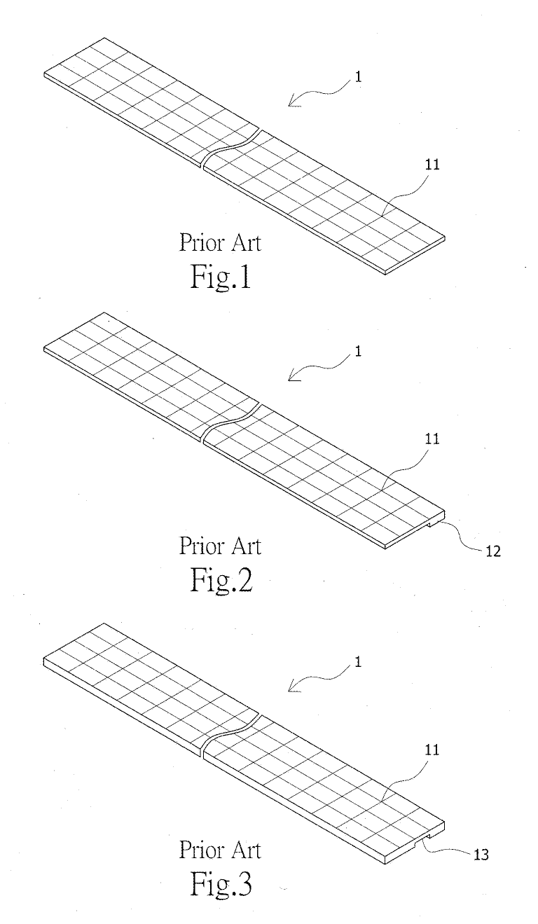

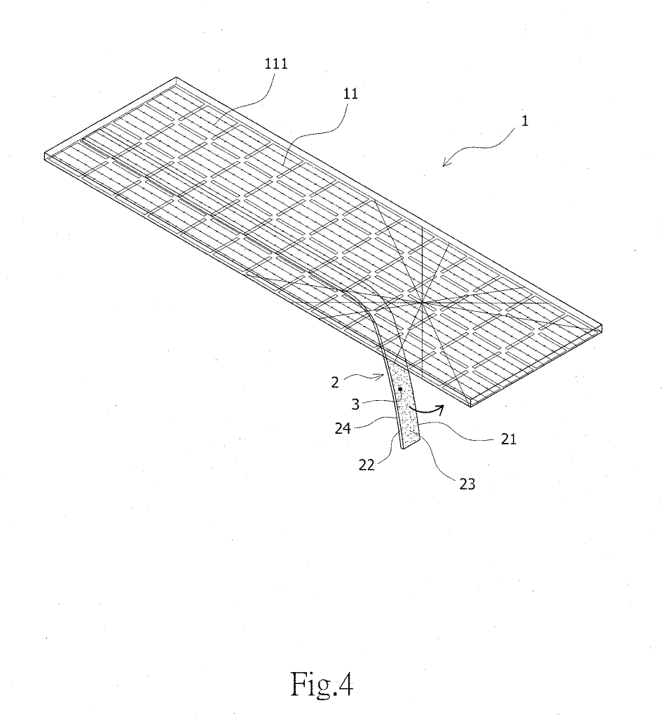

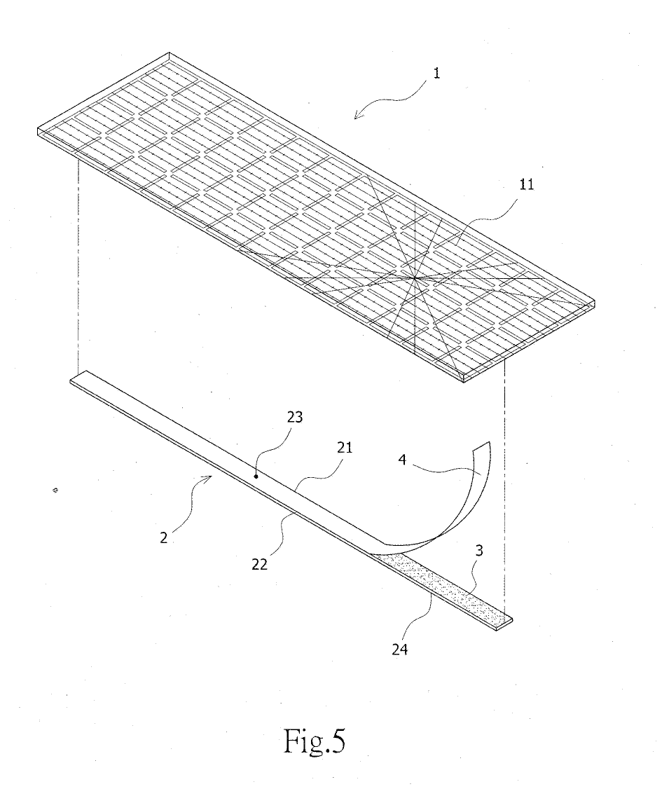

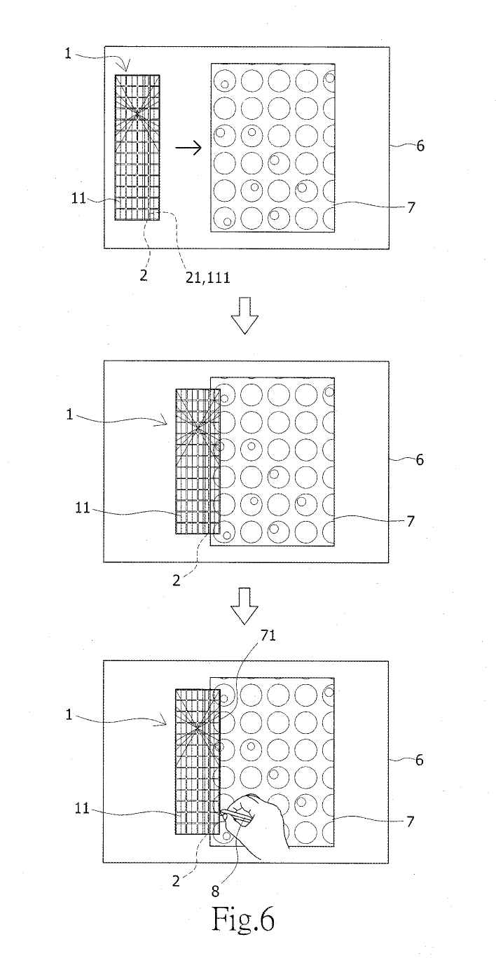

### DETAILED DESCRIPTION OF THE PREFERRED EMBODIMENTS

A strip sticker of quilting ruler set is a flat quilting ruler (1) in the upper and lower surface, the one surface of which marked with graduations (11), which is characterized in that: a strip sticker (2) that has first (21) and second side (22) in parallel, and one (23) of two surface (23)(24) coating with a layer of reusable adhesive (3) by which the strip sticker (2) can be used for torn and adhered to quilting ruler (1) repeatedly, said strip sticker (2) is adhered to the other surface of the quilting ruler (1); the length of the strip sticker (2) is less than the quilting ruler (1) preferably, the first side (21) of the strip sticker (2) needs to align along the one of a straight graduation line (111) on quilting ruler (1) before sticking together, thereby the first side (21) of the strip sticker (2) can be used as a resistance in the side edge of cloth. In this way, the old type of quilting ruler can become a more precise measurement of ruler with a strip sticker (2).

The length of said strip sticker (2) can also the same as the quilting ruler (1) or longer by connected two or three strip stickers (2), but considering the measurement precisely, the one single strip sticker (2) is preferable.

Said reusable adhesive (3) is covered by a removable release paper (4) prior to use. The purpose of the release paper (4) is to prevent the reusable adhesive (3) from dust accumulation prior to stick to the quilting ruler (1).

Said reusable adhesive (3) is made of a water-based PVC adhesive which can remain adhesiveness following the water washing and use repeatedly; in addition, it can also use in other same quality of adhesives, so everything that can use repeatedly for the strip sticker (2) adhered to the quilting ruler (1) is within the scope of the invention.

The thickness of the strip sticker (2) is no more than the one of the quilting ruler (1), but it must be greater than 0.3 mm; if the thickness is bigger than the quilting ruler, it will be heavy weight and difficult to use; if the thickness is smaller than 0.3 mm, it will reduce resistance for in the side edge of cloth.

The width of the strip sticker (2) is between 0.7 mm and 2 cm preferably. If the width is smaller than 0.7 mm, it will lose the resistance in the side edge of cloth; if the width is bigger than 2 cm, it will waste too many materials.

Said strip sticker (2) can be replaced in other materials as follow, which is: a soft plastic material, a toughness of paper material and an acrylic material.

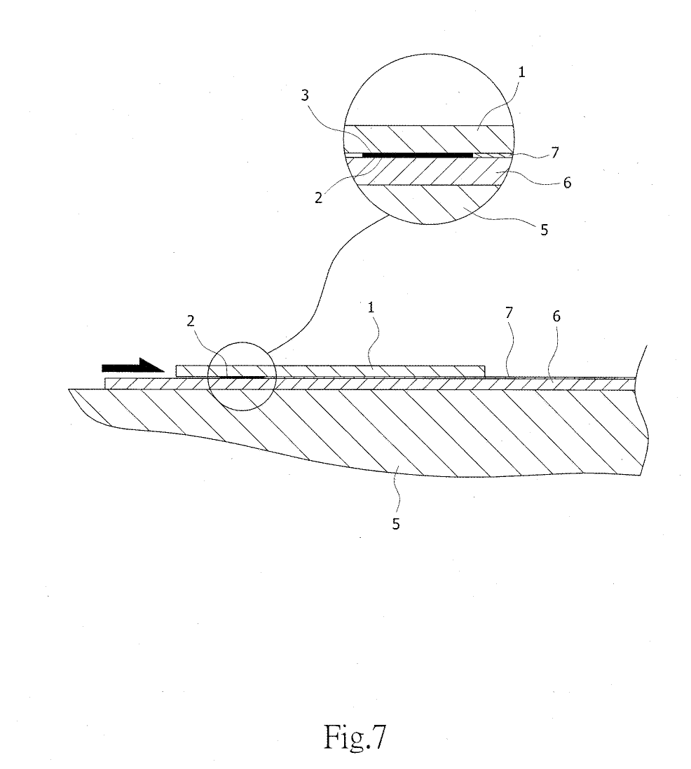

FIG. 6 is a schematic view showing the use of quilting ruler on cloth, which discloses a cloth (7) laid flat on a plate (6) of the table (5)(also shown in FIG. 7), confirm the line (2) position of quilting ruler (1) before sticking together. First, align the first side (21) of the strip sticker (2) along one the straight graduation lines (111) and then adhere together; second, move the quilting ruler (1) to the cloth (7) and slide it up and down along the cloth (7) edge as shown in the second drawing of FIG. 6, the quilting ruler (1) can lean against the edge of cloth (7) by a protruding part under the quilting ruler (1) for stopping movement to the right as also shown in FIG. 7; the operator can draw a first line (71) on the cloth (7) along the side edge of the quilting ruler (1) by a chalk (8) as shown in third drawing of FIG. 6, the line is either a unfolding line or a sewing line.

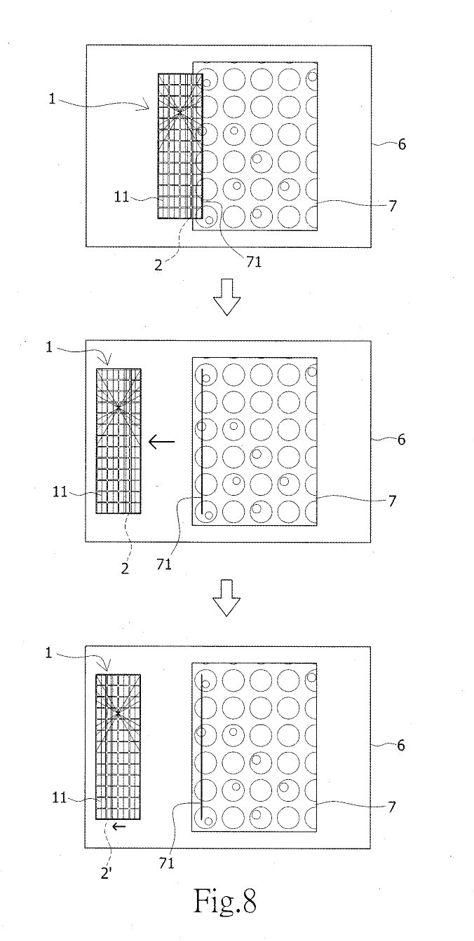

First drawing of FIG. 8 shows the first line (71) is drawn on the cloth (7) and then moves the quilting ruler (1) to the left as shown in the second drawing of FIG. 8; third, tear down the strip sticker (2) and adhere it to the next new position under the quilting ruler (1) as shown in the third drawing of FIG. 8

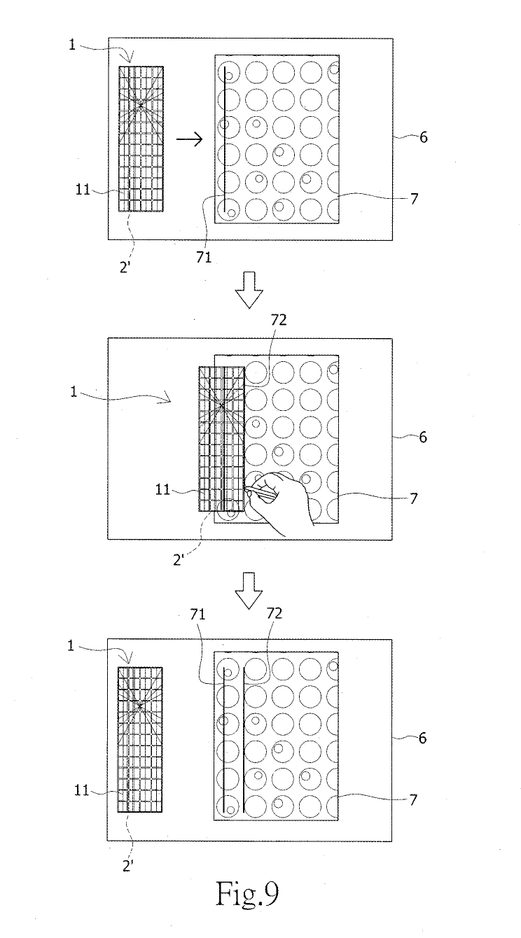

First drawing of FIG. 9 shows the first line (71) is drawn on the cloth (7) and then draw the second line (72) paralleled in first line (71) on the cloth(7) by tearing down strip sticker and adhered it (2) again under the quilting ruler (1) as shown in the second and third drawings of the FIG. 9.

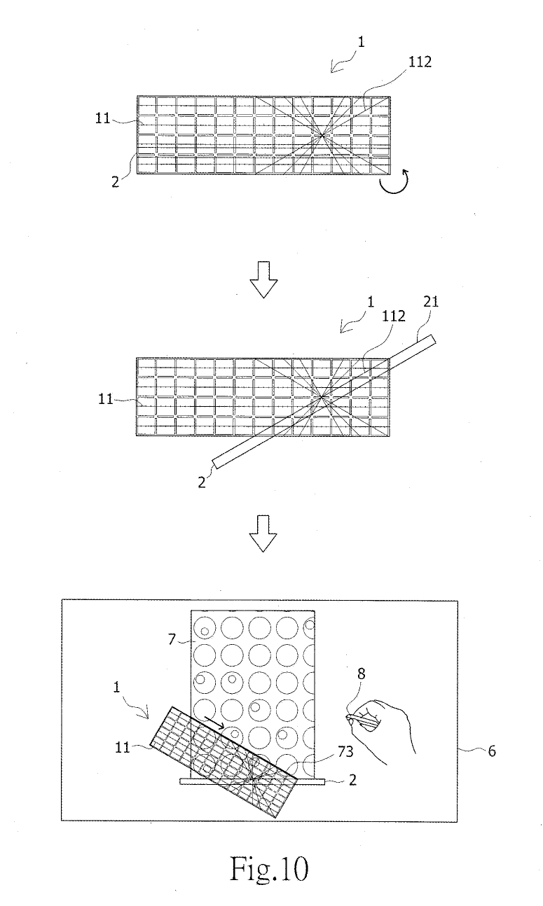

As shown in FIG. 10, the quilting ruler (1) has straight graduation lines (111) and oblique graduation lines (112), when operator want to draw an oblique line (73) on the cloth (7), he need to overlay the first line (21) of the strip sticker (2) on the oblique graduation line (112) of the quilting ruler (1) and then adhere together. In this way, operator can draw a specific angle of oblique line (73) on the cloth (7) quickly.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood.

I claim:

1. A strip sticker of quilting ruler set is a flat quilting ruler (1) in the upper and lower surface, the one surface of which marked with graduations (11), which is characterized in that:
a strip sticker (2) that has first (21) and second side (22) in parallel, and one (23) of two surface (23) (24) coating with a layer of reusable adhesive (3) by which the strip sticker (2) can be used for torn and adhered to quilting ruler (1) repeatedly, said strip sticker (2) is adhered to the other surface of the quilting ruler (1);
the length of the strip sticker (2) is less than the quilting ruler (1) preferably, the first side (21) of the strip sticker (2) needs to align along the one of a straight graduation line (111) on quilting ruler (1) before sticking together.

2. A strip sticker of quilting ruler set according to claim 1, said reusable adhesive (3) is covered by a removable release paper (4) prior to use.

3. A strip sticker of quilting ruler set according to claim 1, said reusable adhesive (3) is made of a water-based PVC adhesive.

4. A strip sticker of quilting ruler set according to claim 1, the thickness of the strip sticker (2) is no more than the one of the quilting ruler (1), but it must be greater than 0.3 mm.

5. A strip sticker of quilting ruler set according to claim 1, the width of the strip sticker (2) is between 0.7 mm and 2 cm preferably.

6. A strip sticker of quilting ruler set according to claim 1, said strip sticker (2) is a soft plastic material.

7. A strip sticker of quilting ruler set according to claim 1, said strip sticker (2) is a toughness of paper material, said paper material is a waterproof preferably.

8. A strip sticker of quilting ruler set according to claim 1, said strip sticker (2) is an acrylic material.
